(19) United States
(12) Patent Application Publication
(10) Pub. No.: US 2021/0364675 A1
(43) Pub. Date: Nov. 25, 2021

(54) LIGHT BLOCKING SHEET AND LENS MODULE

(71) Applicant: ZHEJIANG SUNNY OPTICS CO., LTD., Yuyao City (CN)

(72) Inventors: Fang ZHANG, Yuyao City (CN); Fujian DAI, Yuyao City (CN); Liefeng ZHAO, Yuyao City (CN)

(73) Assignee: ZHEJIANG SUNNY OPTICS CO., LTD., Yuyao City (CN)

(21) Appl. No.: 17/130,355

(22) Filed: Dec. 22, 2020

(30) Foreign Application Priority Data
May 25, 2020 (CN) 202020888455.2

(51) Int. Cl. G02B 5/00; G02B 7/02

(52) U.S. Cl. CPC G02B 5/005; G02B 7/02

(57) ABSTRACT

The present disclosure relates to a light blocking sheet and a lens module, wherein the light blocking sheet comprises a main body, which is provided with a through hole that penetrates a body of the main body, wherein the through hole is an axisymmetric profiled hole. The through hole in the light blocking sheet is configured as an axisymmetric profiled hole, which realizes the optimization and adjustment of the light-passing structure of the middle position of the light blocking sheet, so that the light blocking sheet of the present disclosure have a better effect of suppressing stray light, and it is more advantageous to improve the performance and quality of the imaging device using the light blocking sheet.

### CROSS-REFERENCE TO RELATED APPLICATIONS

The present application claims the priority of Chinese utility model application No. 202020888455.2, filed on May 25, 2020, which is hereby incorporated by reference in its entirety.

### TECHNICAL FIELD

The present disclosure relates to the field of optics, and in particular to a light blocking sheet and a lens module.

### TECHNICAL BACKGROUND

In recent years, portable electronic products have developed rapidly, especially mobile phones, tablet computers, etc. have flooded the lives of modern people, and imaging devices mounted in the portable electronic products have also flourished accordingly. With the development of technology, the users have higher and higher requirements for the quality of portable electronic devices. Therefore, on the basis of the prior art, optimizing internal components to improve their performance and quality so as to meet the users' requirements has become the driving force and goal of continuous innovation for relevant practitioners.

### SUMMARY

An objective of the present disclosure is to provide a light blocking sheet and a lens module, wherein the structure of the light blocking sheet is optimized to improve the imaging quality of imaging device.

In order to achieve the above objective of the present disclosure, the present disclosure provides a light blocking sheet, comprising a main body, which is provided with a through hole that penetrates a body of the main body;
wherein the through hole is an axisymmetric profiled hole.

According to an aspect of the present disclosure, an inner side surface of the through hole is a profiled surface formed by multiple pairs of structural faces connected to each other.

According to an aspect of the present disclosure, each pair of the structural faces comprises two mirror-symmetric structural faces.

According to an aspect of the present disclosure, the structural faces are circular arc faces.

According to an aspect of the present disclosure, the inner side surface of the through hole is a profiled surface formed by two pairs of structural faces connected to each other, which are a first structural face pair and a second structural face pair, respectively.

According to an aspect of the present disclosure, a radius R1 of curvature of two first structural faces included in the first structural face pair satisfies: 0.1 mm≤R1≤20 mm; and
a radius R2 of curvature of two second structural faces included in the second structural face pair satisfies: 0.1 mm≤R2≤20 mm.

According to an aspect of the present disclosure, the maximum distance W1 and the minimum distance W2 between the inner side surface of the through hole and a central optical axis of the light blocking sheet satisfy: W1>W2.

According to an aspect of the present disclosure, the maximum distance W1 and the minimum distance W2 between the inner side surface of the through hole and the central optical axis of the light blocking sheet satisfy: W2>0.1 mm, W1<6.0 mm, and 1<W1/W2<20.

According to an aspect of the present disclosure, a thickness H of the light blocking sheet satisfies: 0.01 mm≤H≤0.2 mm.

According to an aspect of the present disclosure, the light blocking sheet is a single-layer structure made of a metal material or a non-metal material.

According to an aspect of the present disclosure, the light blocking sheet is a multi-layer structure composed of a composite material, in which a center interlayer is a PET base layer or a PI base layer, and an outer layer covering an outer side of the center interlayer is a carbon fiber layer.

According to an aspect of the present disclosure, the light blocking sheet is formed by one-time processing.

In order to achieve the above objective of the present disclosure, the present disclosure provides a lens module, comprising a lens barrel, at least one lens provided in the lens barrel, and at least one light blocking sheet as described above provided in the lens barrel.

According to a solution of the present disclosure, the through hole in the light blocking sheet is configured as an axisymmetric profiled hole, which realizes the optimization and adjustment of the light-passing structure of the middle position of the light blocking sheet, so that the light blocking sheet of the present disclosure have a better effect of suppressing stray light, and it is more advantageous to improve the performance and quality of the imaging device using the light blocking sheet.

According to a solution of the present disclosure, the inner side surface of the through hole is configured as multiple pairs of symmetrical structural faces connected to each other, so that the processing and manufacturing are relatively simple in the case where the complex structure is satisfied. In addition, the symmetrical structural face pairs are used, which is also advantageous to suppress the generation of edge diffracted stray light, and is convenient to have a good suppression effect on stray light by simply adjusting the structure of the structural face pairs.

According to a solution of the present disclosure, the maximum distance W1 and the minimum distance W2 between the inner side surface of the through hole and the central optical axis of the light blocking sheet are set within the above ranges, which effectively suppresses the generation of diffracted stray light and improves the imaging quality of imaging devices using the light blocking sheet of the present disclosure.

According to a solution of the present disclosure, the thickness of the light blocking sheet is set within the above range, so that in the case where the strength and quality of the light blocking sheet are ensured, the processing and assembly process of the light blocking sheet can be ensured to be stable, thereby facilitating to ensure the stable quality of devices using the imaging device of the present disclosure.

According to a solution of the present disclosure, the light blocking sheet of the present disclosure is integrally processed into a single-layer structure using a metal or non-metal material, which not only has high processing efficiency and processing quality, but also has low processing cost.

According to a solution of the present disclosure, the light blocking sheet of the present disclosure is integrally processed into a multi-layer structure using a composite material, which not only has a good suppression effect on imaging stray light, but also can effectively improve processing efficiency and processing quality.

### BRIEF DESCRIPTION OF THE DRAWINGS

FIG. 1 schematically shows a perspective view of a light blocking sheet according to an implementation of the present disclosure;

FIG. 2 schematically shows a front view of the light blocking sheet according to the implementation of the present disclosure;

FIG. 3 schematically shows a sectional view of the light blocking sheet according to the implementation of the present disclosure;

FIG. 4 schematically shows a front view of a light blocking sheet according to another implementation of the present disclosure;

FIG. 5 schematically shows a front view of a light blocking sheet according to another implementation of the present disclosure;

FIG. 6 schematically shows a front view of a light blocking sheet according to another implementation of the present disclosure;

FIG. 7 schematically shows a structural view of a lens module according to an implementation of the present disclosure; and

FIG. 8 schematically shows an enlarged view of position A in FIG. 7.

### DETAILED DESCRIPTION OF THE EMBODIMENTS

In order to more clearly explain the technical solutions in the implementations of the present disclosure or the prior art, the drawings that need to be used in the implementations will be briefly introduced below. Obviously, the drawings in the following description are only some of the implementations of the present disclosure, and for an ordinary person skilled in the art, other drawings may also be obtained from these drawings without making creative efforts.

When the implementations of the present disclosure are described, the orientation or positional relationships indicated by the terms “longitudinal”, “transverse”, “upper”, “lower”, “front”, “rear”, “left”, “right”, “vertical”, “horizontal”, “top”, “bottom”, “inside” and “outside” are based on the orientation or positional relationships shown in the relevant figures, which is merely for the convenience of describing the present disclosure and simplifying the description, and does not indicate or imply that the mentioned apparatus or element must have a particular orientation and be constructed and operated in the particular orientation. Therefore, the above terms cannot be construed as limiting the present disclosure.

The present disclosure will be described below in detail in conjunction with the drawings and specific implementations. The implementations cannot be repeated here, but the implementations of the present disclosure are not limited to the following implementations.

As shown in FIG. 1, according to an implementation of the present disclosure, a light blocking sheet of the present disclosure includes: a main body 1. In this implementation, the main body 1 are provided with a through hole 11 that penetrates the body of the main body 1. In this implementation, the through hole 11 is an axisymmetric profiled hole.

Through the above arrangement, the through hole in the light blocking sheet is configured as an axisymmetric profiled hole, which realizes the optimization and adjustment of the light-passing structure of the middle position of the light blocking sheet, so that the light blocking sheet of the present disclosure have a better effect of suppressing stray light, and it is more advantageous to improve the performance and quality of the imaging device using the light blocking sheet.

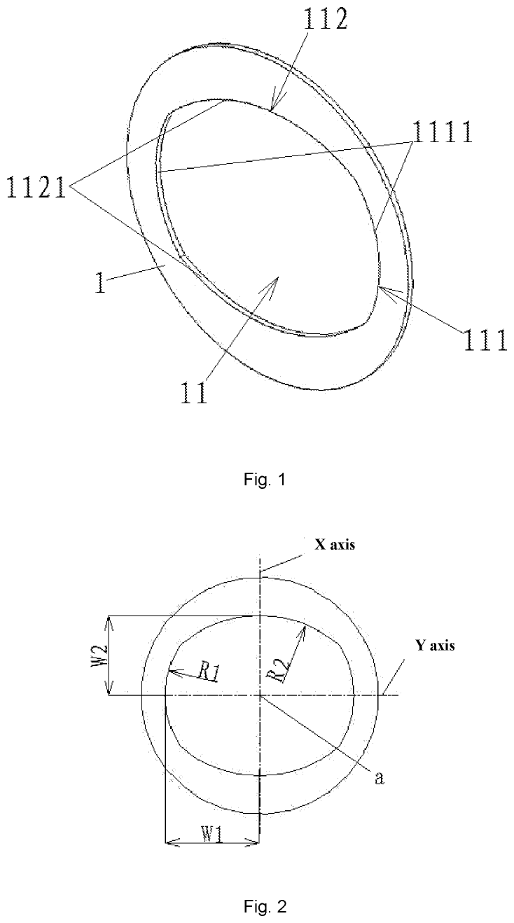

As shown in FIGS. 1 and 2, according to an implementation of the present disclosure, an inner side surface of the through hole 11 is a profiled surface formed by multiple pairs of structural faces connected to each other. In this implementation, each pair of structural faces includes two mirror-symmetrical structural faces (referring to FIG. 2, the structural faces included in each pair of structural faces are symmetrical about a corresponding symmetry axis). Through the above arrangement, the inner side surface of the through hole 11 is configured as multiple pairs of symmetrical structural faces connected to each other, so that the processing and manufacturing are relatively simple in the case where the complex structure is satisfied. In addition, the symmetrical structural face pairs are used, which is also advantageous to suppress the generation of edge diffracted stray light, and is convenient to have a good suppression effect on stray light by simply adjusting the structure of the structural face pairs.

In this implementation, both the outer side surface and the inner side surface of the through hole 11 are arranged parallel to a central optical axis a. Furthermore, the opposite sides of the main body 1 have the same projected shape along an axial direction of the central optical axis.

As shown in FIGS. 1 and 2, according to an implementation of the present disclosure, the structural faces forming the structural face pair are circular arc faces.

As shown in FIGS. 1 and 2, according to an implementation of the present disclosure, the inner side surface of the through hole 11 is a profiled surface formed by two pairs of structural faces connected to each other, which are a first structural face pair 111 and a second structural face pair 112, respectively. In this implementation, a radius R1 of curvature of two first structural faces 1111 included in the first structural face pair 111 satisfies: 0.1 mm≤R1≤20 mm; and a radius R2 of curvature of two second structural faces 1121 included in the second structural face pair 112 satisfies: 0.1 mm≤R2≤20 mm. Through the above arrangement, the radii of curvature of the structural face pairs are set within the above ranges, ensuring that the aperture of the through hole 11 matches the amount of light passing through the imaging device, ensuring that it has an excellent anti-stray light effect, and facilitating to improve the imaging quality of the imaging device.

As shown in FIGS. 1 and 2, according to an implementation of the present disclosure, the maximum distance W1 and the minimum distance W2 between the inner side surface of the through hole 11 and the central optical axis a of the light blocking sheet satisfy: W1>W2. In this implementation, the maximum distance W1 and the minimum distance W2 between the inner side surface of the through hole 11 and the central optical axis of the light blocking sheet satisfy: W2>0.1 mm, W1<6.0 mm, and 1<W1/W2<20. Through the above arrangement, the maximum distance W1 and the minimum distance W2 between the inner side surface of the through hole 11 and the central optical axis a of the light blocking sheet are set within the above ranges, which effectively suppresses the generation of diffracted stray light and improves the imaging quality of imaging devices using the light blocking sheet of the present disclosure.

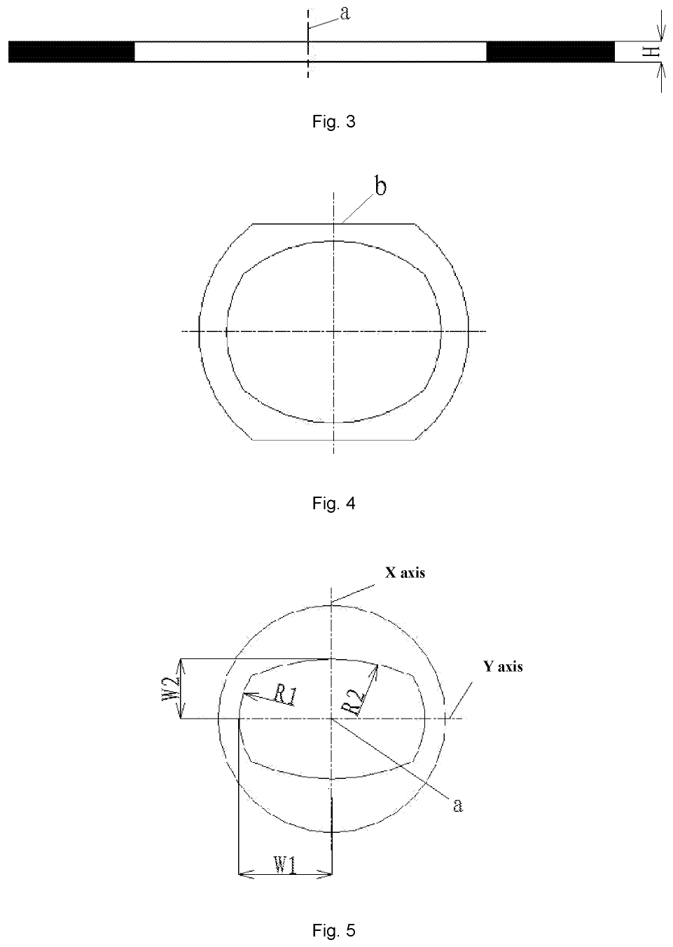

As shown in FIG. 3, according to an implementation of the present disclosure, a thickness H of the light blocking sheet satisfies: 0.01 mm≤H≤0.2 mm. Through the above arrangement, the thickness of the light blocking sheet is set within the above range, so that in the case where the strength and quality of the light blocking sheet are ensured, the processing and assembly process of the light blocking sheet can be ensured to be stable, thereby facilitating to ensure the stable quality of devices using the imaging device of the present disclosure.

As shown in FIGS. 1, 2 and 4, according to another implementation of the present disclosure, a cut b may further be provided on the outer side surface of the main body 1. Through the above arrangement, by changing the shape and structure of the light blocking sheet, it can be effectively matched with the installation location, thereby making the installation of the light blocking sheet more flexible.

According to an implementation of the present disclosure, the light blocking sheet is a single-layer structure made of a metal or non-metal material. In this implementation, the light blocking sheet is formed by one-time processing. Through the above arrangement, the light blocking sheet of the present disclosure is integrally processed into a single-layer structure using a metal or non-metal material, which not only has high processing efficiency and processing quality, but also has low processing cost.

According to another implementation of the present disclosure, the light blocking sheet is a multi-layer structure composed of a composite material, in which a center interlayer is a PET base layer or a PI base layer, and an outer layer covering an outer side of the center interlayer is a carbon fiber layer. In this implementation, the light blocking sheet is formed by one-time processing. Through the above arrangement, the light blocking sheet of the present disclosure is integrally processed into a multi-layer structure using a composite material, which not only has a good suppression effect on imaging stray light, but also can effectively improve processing efficiency and processing quality.

The present disclosure is illustrated with examples in conjunction with the drawings.

### Embodiment 1

As shown in FIG. 2, in this embodiment, the inner side surface of the through hole 11 includes two pairs of structural faces, wherein two structural faces in one structural face pair are symmetrical about an X axis, and two structural faces in the other structural face pair are symmetrical about a Y axis. The shape of the projection of the light blocking element in the direction along the central optical axis is the same with respect to the two lateral directions. In this embodiment, the maximum distance W1 and the minimum distance W2 from the inner side surface of the through hole 11 to the central optical axis a are W1=2.27 mm and W2=1.93 mm, respectively, which satisfy W1>W2, and W1/W2=1.17. Referring to FIG. 1, the radius of curvature of the first structural face 1111 in the first structural face pair 111 on the inner side of the through hole 11 is R1, and the radius of curvature of the second structural face 1121 in the second structural face pair 112 is R2, which satisfy: R1=2.27 mm and R2=2.93 mm. In this embodiment, the light blocking sheet and the through hole 11 at the middle position thereof are integrally processed, and the material of the light blocking sheet is a plastic material. In this embodiment, the thickness of the light blocking sheet is H=0.02 mm. The light blocking sheet with the above arrangement has a simple structure and low cost. Moreover, in the case where the inner side surface of the through hole 11 adopts the above-mentioned parameters and structure, the generation of diffracted stray light is effectively suppressed, and the imaging quality of the imaging device using the light blocking sheet of the present disclosure is improved.

### Embodiment 2

As shown in FIG. 5, in this embodiment, the inner side surface of the through hole 11 includes two pairs of structural faces, wherein two structural faces in one structural face pair are symmetrical about an X axis, and two structural faces in the other structural face pair are symmetrical about a Y axis. The shape of the projection of the light blocking element in the direction along the central optical axis is the same with respect to the two lateral directions. In this embodiment, the maximum distance W1 and the minimum distance W2 from the inner side surface of the through hole 11 to the central optical axis a are W1=1.49 mm and W2=1.15 mm, respectively, which satisfy W1>W2, and W1/W2=1.29. Referring to FIG. 1, the radius of curvature of the first structural face 1111 in the first structural face pair 111 on the inner side of the through hole 11 is R1, and the radius of curvature of the second structural face 1121 in the second structural face pair 112 is R2, which satisfy: R1=1.59 mm and R2=2.56 mm. In this embodiment, the light blocking sheet and the through hole 11 at the middle position thereof are integrally processed, and the material of the light blocking sheet is a plastic material. In this embodiment, the thickness of the light blocking sheet is H=0.04 mm. The light blocking sheet with the above arrangement has a simple structure and low cost. Moreover, in the case where the inner side surface of the through hole 11 adopts the above-mentioned parameters and structure, the generation of diffracted stray light is effectively suppressed, and the imaging quality of the imaging device using the light blocking sheet of the present disclosure is improved.

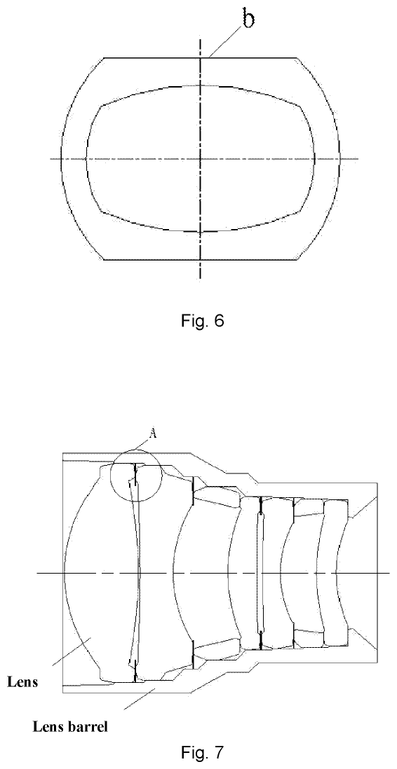

As shown in FIG. 6, according to another implementation thereof, a cut b is further provided on the outer side surface of the light blocking sheet.

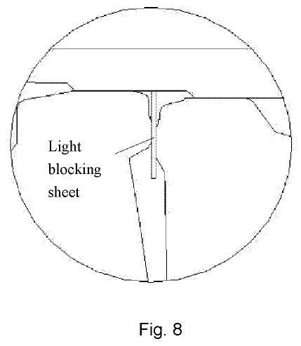

As shown in FIGS. 7 and 8, according to an implementation of the present disclosure, a lens module of the present disclosure includes: a lens barrel, at least one lens provided in the lens barrel, and at least one light blocking sheet provided in the lens barrel. In this implementation, the light blocking sheet is optionally arranged between two adjacent lenses.

The above are only examples of the specific solutions of the present disclosure. For the devices and structures not described in detail, it should be understood as adopting the existing common devices and common methods in the art to implement.

The above is only one solution of the present disclosure and is not intended to limit the present disclosure. For those skilled in the art, the present disclosure may have various modifications and variants. Any modification, equivalent replacement, improvement and so on made within the spirit and principle of the present disclosure shall be included in the scope of protection of the present disclosure.

What is claimed is:

1. A light blocking sheet, comprising a main body, which is provided with a through hole that penetrates a body of the main body;
wherein the through hole is an axisymmetric profiled hole.

2. The light blocking sheet according to claim 1, wherein an inner side surface of the through hole is a profiled surface formed by multiple pairs of structural faces connected to each other.

3. The light blocking sheet according to claim 2, wherein each pair of the structural faces comprises two mirror-symmetric structural faces.

4. The light blocking sheet according to claim 3, wherein the structural faces are circular arc faces.

5. The light blocking sheet according to claim 4, wherein the inner side surface of the through hole is a profiled surface formed by two pairs of structural faces connected to each other, which are a first structural face pair and a second structural face pair, respectively.

6. The light blocking sheet according to claim 5, wherein a radius R1 of curvature of two first structural faces included in the first structural face pair satisfies: 0.1 mm≤R1≤20 mm; and
a radius R2 of curvature of two second structural faces included in the second structural face pair satisfies: 0.1 mm≤R2≤20 mm.

7. The light blocking sheet according to claim 1, wherein the maximum distance W1 and the minimum distance W2 between the inner side surface of the through hole and a central optical axis of the light blocking sheet satisfy: W1>W2.

8. The light blocking sheet according to claim 7, wherein the maximum distance W1 and the minimum distance W2 between the inner side surface of the through hole and the central optical axis of the light blocking sheet satisfy: W2>0.1 mm, W1<6.0 mm, and 1<W1/W2<20.

9. The light blocking sheet according to claim 1, wherein a thickness H of the light blocking sheet satisfies: 0.01 mm≤H≤0.2 mm.

10. The light blocking sheet according to claim 1, wherein the light blocking sheet is a single-layer structure made of a metal material or a non-metal material.

11. The light blocking sheet according to claim 1, wherein the light blocking sheet is a multi-layer structure composed of a composite material, in which a center interlayer is a PET base layer or a PI base layer, and an outer layer covering an outer side of the center interlayer is a carbon fiber layer.

12. The light blocking sheet according to claim 1, wherein the light blocking sheet is formed by one-time processing.

13. A lens module, comprising a lens barrel, at least one lens provided in the lens barrel, and at least one light blocking sheet provided in the lens barrel, wherein the light blocking sheet comprises a main body, which is provided with a through hole that penetrates a body of the main body, and wherein the through hole is an axisymmetric profiled hole.
